(19) United States
(12) Patent Application Publication
(10) Pub. No.: US 2014/0172378 A1
(43) Pub. Date: Jun. 19, 2014

(54) APPARATUS AND METHOD FOR CREATING FLOOR PLAN OF BUILDING

(71) Applicant: Samsung Electronics Co., Ltd., Suwon-si (KR)

(72) Inventors: Jung-Hyun SHIM, Seongnam-si (KR); Ji-Hyeon KWEON, Yongin-si (KR); Kang-Min LEE, Hwaseong-si (KR); Seung-Uk LEE, Goyang-si (KR); Sun-Mi JIN, Yongin-si (KR)

(73) Assignee: Samsung Electronics Co., Ltd., Suwon-si (KR)

(21) Appl. No.: 14/104,372

(22) Filed: Dec. 12, 2013

(30) Foreign Application Priority Data
Dec. 14, 2012 (KR) 10-2012-0146067

(51) Int. Cl. G06F 17/50

(52) U.S. Cl. CPC G06F 17/5004
USPC 703/1

(57) ABSTRACT

An apparatus and a method for creating a floor plan of a building using a program that supports an editing operation of an interior structural drawing are provided. The method includes receiving a request of a user from a User Interface (UI) unit, searching at least one of a DataBase (DB) and an external DB, which is accessible through a communication unit, based on the basic layout information to obtain at least one recommended interior structural drawing, providing the at least one recommended interior structural drawing through the UI unit, editing the interior structural drawing selected by the user based on extended layout information.

### CROSS-REFERENCE TO RELATED APPLICATION(S)

This application claims the benefit under 35 U.S.C. §119(a) of a Korean patent application filed on Dec. 14, 2012 in the Korean Intellectual Property Office and assigned Serial No. 10-2012-0146067, the entire disclosure of which is hereby incorporated by reference.

### TECHNICAL FIELD

The present disclosure relates to creating a floor plan of a building. More particularly, the present disclosure relates to an apparatus and a method for creating a floor plan of a building using a program that supports an editing operation of an interior structural drawing.

### BACKGROUND

Technological advancements in communication technologies enable a home network system to be combined with various short-range wireless communication technologies. For example, a short-range wireless communication technology enables interworking of electronics at home where a home network system is implemented.

It is expected that the home network system may need to be implemented optimally for various interior structures. In order to improve utilization of the home network system and for optimization of the interior structure, a drawing illustrating the interior structure (hereinafter, referred to as an “interior structural drawing”) is needed.

The interior structural drawing may be classified depending on its expression form. For example, the interior structural drawing may be classified as a 2-Dimensional (2D) floor plan and a 3-Dimensional (3D) stereogram. The floor plan may be classified depending on a degree of expression, for example, into a rough floor plan showing an internal space by dividing it with simple lines and a detailed floor plan showing an internal space based on the thickness of walls and internal wiring.

The interior structural drawing needs to be created suitably for its purpose. For example, the interior structural drawing for object arrangement at home may be created in a 2D form, since the 2D form is useful to accurately express size and shape of each space. However, the interior structural drawing for an interior lighting work using electric wiring installed in a building may be created using both the 2D form and the 3D form since the use of both the 2D form and the 3D form is useful to express electric wiring formed using walls that divide the internal space. For the interior design of the building, the interior structural drawing may be created in the 3D form to optimize the space of the interior structure.

A suitable interior structural drawing may be one already created for another interior structure of a home network system, or may be obtained by creating a new diagram manually or by using a related computer program.

Generally, creating or editing an interior structural drawing is difficult and complicated, and therefore, a need exists for an apparatus and a method for creating a floor plan of a building using a program that supports an editing operation of an interior structural drawing.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an apparatus and a method for creating a drawing illustrating an interior layout of a building and for managing the created drawing.

Another aspect of the present disclosure is to provide an apparatus and a method for collecting information about an interior layout using basic input information, editing an interior structural drawing created using the collected information, and outputting and storing the edited interior structural drawing.

In accordance with an aspect of the present disclosure, a Home GateWay (HGW) for providing an interior structural drawing of a building is provided. The HGW includes a User Interface (UI) unit, a DataBase (DB) configured to manage interior structural drawings based on identification information, a communication unit configured to communicate with an external network, and a structural drawing unit configured to receive a request of a user from the UI unit, to obtain at least one recommended interior structural drawing by searching at least one of the DB and an external DB, which is accessible through the communication unit, based on the basic layout information, to provide the at least one recommended interior structural drawing through the UI unit, and to edit the interior structural drawing selected by the user based on extended layout information.

In accordance with another aspect of the present disclosure, a method for providing an interior structural drawing of a building by a HGW that includes a UI unit, a DB configured to manage interior structural drawings based on identification information, and a communication unit configured to communicate with an external network is provided. The method includes receiving a request of a user from the UI unit, obtaining at least one recommended interior structural drawing by searching at least one of the DB and an external DB, which is accessible through the communication unit, based on the basic layout information, providing the at least one recommended interior structural drawing through the UI unit, and editing an interior structural drawing selected by the user from among the at least one recommended interior structural drawing based on the extended layout information.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a schematic diagram illustrating a structure of a home network system according to an embodiment of the present disclosure;

FIG. 2 is a block diagram illustrating a structure for creating an interior structural drawing in a home network system according to an embodiment of the present disclosure;

FIG. 3 is a flowchart illustrating a method for creating an interior structural drawing in a home network system according to an embodiment of the present disclosure;

FIG. 4 is a flowchart illustrating a method for creating an interior structural drawing in a home gateway according to an embodiment of the present disclosure;

FIG. 5 is a flowchart illustrating a method for creating an interior structural drawing in a Home GateWay (HGW) according to an embodiment of the present disclosure;

FIG. 6 illustrates a 2-Dimensional (2D) floor plan according to an embodiment of the present disclosure;

FIG. 7 illustrates a 3-Dimensional (3D) floor plan according to an embodiment of the present disclosure;

FIG. 8 illustrates an edition result after adding a structure corresponding to a living room as an image in an interior structural drawing according to an embodiment of the present disclosure;

FIG. 9 illustrates an edition result after adding a structure corresponding to a sitting room as an image in an interior structural drawing according to an embodiment of the present disclosure; and

FIG. 10 illustrates an edition result after adding a structure corresponding to a bath room as an image in an interior structural drawing according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalent. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

An embodiment of the present disclosure described below proposes a method for creating a floor plan of a building using a program that supports an editing operation of an interior structural drawing and editing the created floor plan at the request of a user.

To provide an interior structural drawing that adequately reflects details of the request of the user, thoughts of the user need to be recognized. To recognize the user's thoughts, details of the request of the user need to be reflected.

Moreover, to obtain an interior structural drawing that sufficiently reflects the recognized user's thoughts, a process of collecting a sufficient amount of related information has to be preceded. To collect a sufficient amount of information, various methods for information collection are needed.

For example, for an apartment house, basic interior structures are substantially identical or similar from family to family, except for arrangement of furniture or electronics. Thus, a floor plan of an apartment house provided by any of a construction company, a distribution company, a real estate agent, or the like, may be used. For example, a final interior structural drawing may be completed by arranging furniture or electronics on the provided floor plan.

The completed interior structural drawing may be open for sharing or stored and managed, allowing a desired interior structural drawing to be obtained without an additional operation, such as a future editing operation.

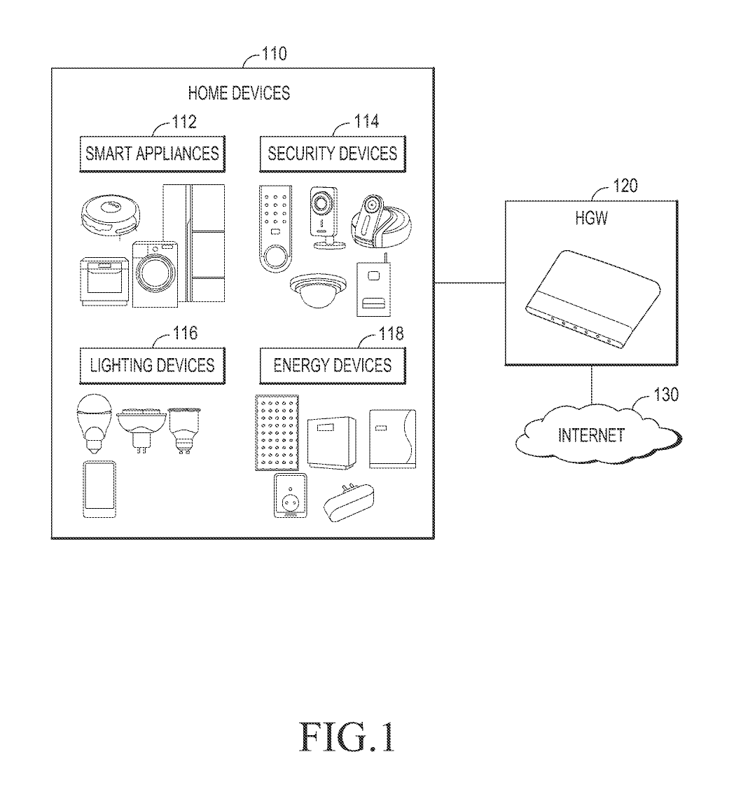

FIG. 1 is a schematic diagram illustrating a structure of a home network system according to an embodiment of the present disclosure.

Referring to FIG. 1, home devices 110 are controlled by a Home GateWay (HGW) 120 that supports communication with an external network, such as Internet 130. The home devices 110 are located or installed inside or around a building and may include smart appliances 112, security devices 114, lighting devices 116, and energy devices 118.

For example, the smart appliances 112 may include a refrigerator, a washing machine, a robot vacuum cleaner, and the like. The security devices 114 may include a door lock system, a security camera, a security sensor, and so forth. The lighting devices 116 may include a Light Emitting Diode (LED) lighting device and the like. The energy devices 118 may include a power meter, a power socket, an electric outlet, a multi-tap, and so forth. The home devices 110 may also include a Personal Computer (PC), an Internet Protocol (IP) camera, an Internet phone, a wired/wireless phone, and a mobile phone.

The home devices 110 may receive information, such as a control command, from the HGW 120 or provide information to the HGW 120. To this end, the home devices 110 support communication with the HGW 110 based on at least one of a wired communication and a wireless communication.

The HGW 120 may include a communication module for communicating with the home devices 110 based on at least one of a wired communication and a wireless communication. The HGW 120 registers therein and stores information about the home devices 110. The HGW 120 controls operations and states of the respective home devices 110 by communicating with the home devices 110 and collects and manages information from the home devices 110.

The HGW 120 is connected to a data network, such as the Internet 130, to allow connection from or to another communication terminal. Thus, the HGW 120 provides information desired by another communication terminal or is provided with its desired information from another communication terminal over the Internet 130.

The HGW 120 may also control a particular home device designated from among the home devices 110, in response to a control signal received from an external communication terminal over the Internet 130. The HGW 120 collects the result of an operation of controlling a particular home device performed at the request of an external communication terminal, and provides the collected result to the external communication terminal.

The home network system may provide a home entertainment service, a home data communication service, a home automation service, and so forth. The home entertainment service may include an Internet TV (IPTV) and a Video on Demand (VoD), which use the Internet 130, and the like. The home data communication service may include data sharing, Voice over IP (VoIP), video communication, and so forth. The home automation service may include remote control and remote gauge examination of electronic appliances, crime prevention, disaster prevention, and the like. The home network system connects most of the home devices 110 used inside and outside the home through a single network to control them.

The user may connect to the HGW 120 included in the home network system and to each home device 110 through the HGW 120, by using wireless communication equipment, such as a mobile terminal, in remote areas.

For example, the mobile terminal that may connect to the HGW 120 over the Internet 130 may be a Personal Digital Assistant (PDA) having a communication function, a smartphone, a cellular phone, a tablet computer, a laptop computer, or the like.

For easy control of the home devices 110, the HGW 120 needs to create structural drawings that reflect interior and exterior layouts of a building where the home devices 110 are installed. The HGW 120 configures a database (DB) of the created interior and exterior structural drawings and accesses the configured DB to update a related interior or exterior structural drawing when necessary. For example, interior and exterior structural drawings may be updated when a layout in a building is changed.

The HGW 120 may use the interior and exterior structural drawings of the DB to measure and manage a lighting environment and a power consumption of each space that divides the interior. For example, for a multi-story (or floor) building, the HGW 120 may indicate the amount of power consumed in each floor or a current lighting use state of each space in each floor by using an interior structural drawing. Moreover, the HGW 120 controls the use of power or lighting in each space, based on the amount of power and the lighting use state that are indicated based on the interior structural drawing.

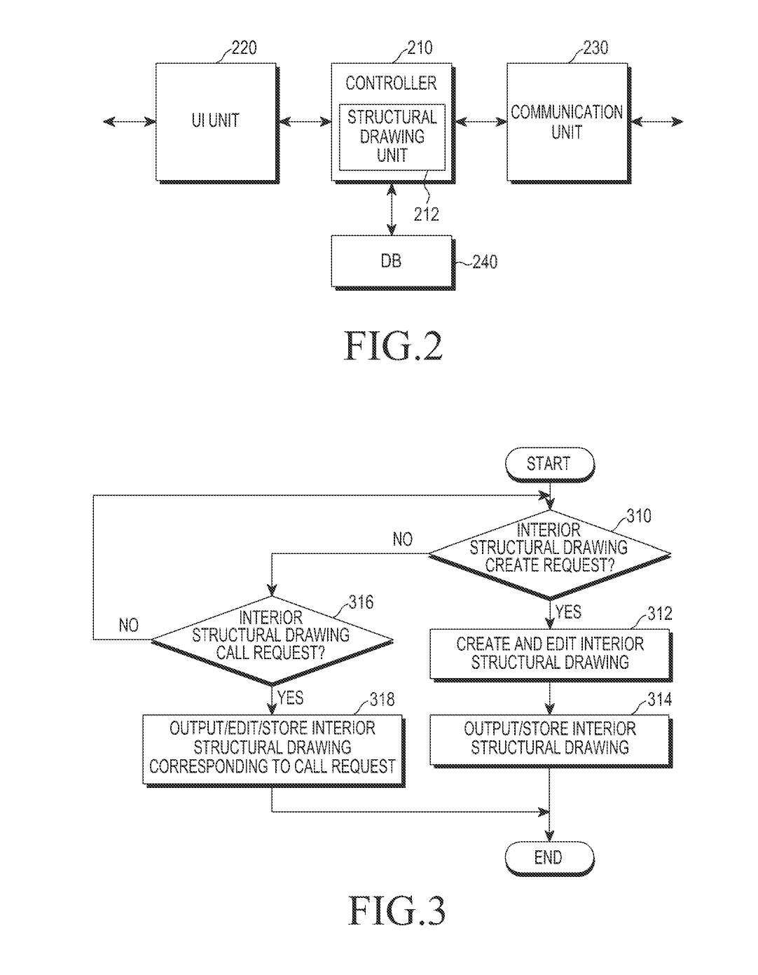

FIG. 2 is a block diagram illustrating a structure for creating an interior structural drawing in a home network system according to an embodiment of the present disclosure. In FIG. 2, a minimum structure used for creating/editing and managing an interior structural drawing proposed in an embodiment of the present disclosure is illustrated and other structures are omitted to facilitate understanding of the embodiment of the present disclosure.

Referring to FIG. 2, a controller 210 controls an overall operation for creating an interior structural drawing. The controller 210 may include a structural drawing unit 212 to control an overall operation for creating and editing an interior structural drawing. The structural drawing unit 212 may be configured with a separate processor or may be implemented with a program module driven in the controller 210.

A User Interface (UI) unit 220 exchanges information with a user to create/retrieve and edit an interior structural drawing. For example, the UI unit 220 receives interior structural drawing create/retrieve and edit requests, is provided with some information from the user for drawing creation/retrieval and edition of the interior structural drawing, and delivers the information to the controller 210.

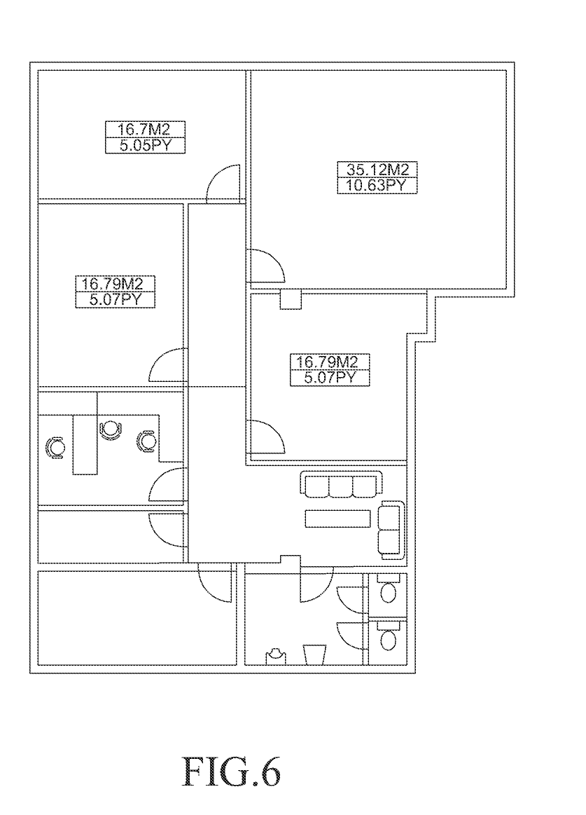

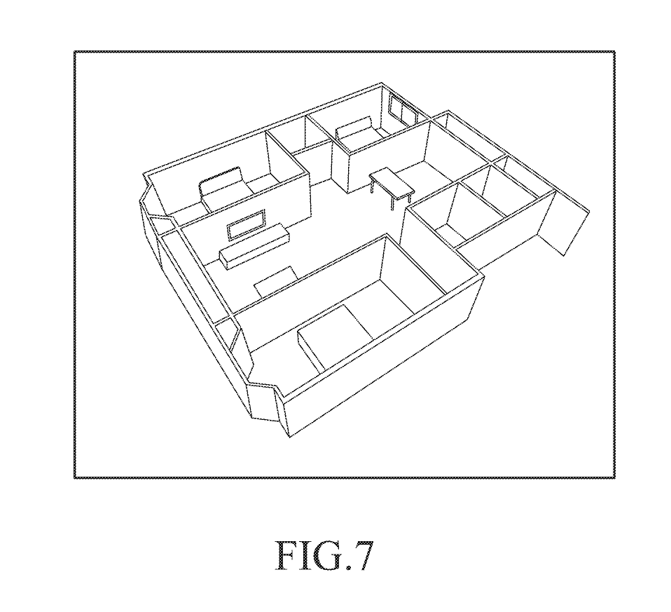

The UI unit 220 is provided with an interior structural drawing that is created/retrieved and edited by the structural drawing unit 212 of the controller 210 in response to the user's interior structural drawing create/retrieve and edit requests, and provides the interior structural drawing to the user. For example, the interior structural drawing may be output to the user through a screen or a printout. FIGS. 6 and 7 illustrate interior structural drawings the UI unit 220 outputs on a screen.

Once creation of an interior structural drawing is requested by the user through the UI unit 220, the structural drawing unit 212 creates the interior structural drawing requested by the user. If information is needed to create the interior structural drawing, the structural drawing unit 212 controls the UI unit 220 to request the user to provide desired information. For example, the structural drawing unit 212 requests the user to provide some basic layout information. The basic layout information refers to information needed to create an interior structural drawing.

An address indicating a location of a building for which an interior structural drawing is to be created may be a representative of the basic layout information, because searching the Internet or an internal DB 240 based on the address may be the fastest and easiest method to obtain an interior structural drawing having a layout similar to the interior of the building.

However, to create a more realistic interior structural drawing, sufficient basic layout information needs to be provided. For example, a type of a building, the number of rooms, the number of bathrooms, and so forth may be added as the basic layout information. The type of a building may be information for identifying whether the building is a residential building, an office building, or a commercial building. For the residential building, the basic layout information may further include information for identifying a type of residence, for example, information for identifying whether the building is an apartment, a villa, a detached house, or the like.

FIG. 6 illustrates a 2-Dimensional (2D) floor plan according to an embodiment of the present disclosure, and FIG. 7 illustrates a 3-Dimensional (3D) floor plan according to an embodiment of the present disclosure. Although not illustrated on a separate drawing, an interior structural drawing may be created for each floor if a building has a multi-floor structure.

Referring to FIGS. 6 and 7, a residential building having a space that is divided into four rooms, one kitchen, one living room, and one bathroom is illustrated. More specifically, from FIG. 6, it may be seen that information about a size of each room is provided as basic layout information to create the interior structural drawing. Even if the information about the size of each room is not provided as the basic layout information, the interior structural drawing obtained using address-based search may include the information about the size of each room.

The structural drawing unit 212 creates the interior structural drawing using the basic layout information provided through the UI unit 220. A method to create the interior structural drawing based on the basic layout information may be implemented in various forms.

For example, one method for obtaining a desired interior structural drawing may be searching for information in the internal DB 240 or through an external network based on the basic layout information. In a case of failing to obtain the desired interior structural drawing using this method, the interior structural drawing may be created using one of automatic creation, wizard-based creation, user-directed creation, and the like.

Automatic creation automatically creates an interior structural drawing based on a basic layout that is constructed from basic layout information. The interior structural drawing created by automatic creation may express the exterior of a building with simple outlines and divide the interior of the building with simple lines. For example, the interior structural drawing created by automatic creation may be a rough floor plan.

For example, if basic layout information is provided which indicates that a building is an apartment of about 125.62 m² having three rooms, two bathrooms, one kitchen, one living room, and one screen porch, an interior structural drawing based on the gathered basic layout information may be created.

Wizard-based creation provides a wizard for helping a user to directly create or change a layout, that is a Graphic User Interface (GUI), through the UI unit 220, and the user creates an interior structural drawing by using a simple edit function or the like provided by the GUI. To this end, the GUI needs to include sufficient fundamental elements the user may select for creation of the interior structural drawing. For example, the GUI may support graphics such as an interior structure, a room shape, a bathroom structure, and so forth according to various space sizes.

Wizard-based creation provides a high-quality interior structural drawing as well as a simple and convenient interface for creation of the interior structural drawing. In spite of the convenient interface, however, the user still has to work to create the interior structural drawing.

User-directed creation allows the user to directly create the interior structural drawing by using a drawing creation program driven in a HGW. In comparison to when the user's freedom is completely supported, the user may experience inconvenience in user-directed creation.

In addition, a combination of the above-described creation methods may also be implemented. For example, after a basic structure is created using automatic creation, a structure of an interior structural drawing may be completed using wizard-based creation. Moreover, the basic structure may be obtained by searching the internal DB 240 or the Internet and the structure may be completed using user-directed creation.

The structural drawing unit 212 creates a plurality of interior structural drawings using the basic layout information, and provides them to the user through the UI unit 220. When one of the plurality of interior structural drawings provided through the UI unit 220 is selected by the user, the structural drawing unit 212 edits the interior structural drawing selected by the user or stores the selected interior structural drawing in the internal DB 240.

The structural drawing unit 212 edits the currently selected interior structural drawing in response to a user's edit request. For example, upon receiving a user's request for changing an existing interior structural drawing, the structural drawing unit 212 retrieves the interior structural drawing from the DB 240 and outputs the retrieved interior structural drawing through the UI unit 220. The user's request may be generated when a position of existing furniture or electronics is changed. Thereafter, according to a user's intention input through the UI unit 220, the structural drawing unit 212 edits the currently output interior structural drawing.

The DB 240 provides information stored at the request of the structural drawing unit 212 or information provided by the structural drawing unit 212.

For example, the DB 240 stores a program corresponding to a wizard for creating an interior structural drawing and a program used for the user to directly create an interior structural drawing. The DB 240 may also store information about the form of the interior, furniture, electronics, the form of a room, and so forth which are expected to be used for creating the interior structural drawing. The DB 240 may also manage an interior structural drawing created by the structural drawing unit 212.

A communication unit 230 communicates with an external network or with home devices existing in the home network system, under control of the controller 210 or the structural drawing unit 212. The communication unit 230 communicates with the external network, such as the Internet, to allow the structural drawing unit 212 to collect information about an interior structural drawing matched to basic layout information.

FIG. 3 is a flowchart illustrating a method for creating an interior structural drawing in a home network system according to an embodiment of the present disclosure. Operations corresponding to the method illustrated in FIG. 3 include an operation of creating the interior structural drawing and an operation of editing the created interior structural drawing. The operation of editing the created interior structural drawing includes an operation of editing a newly created interior structural drawing and an operation of retrieving and editing an existing stored interior structural drawing.

If the user may access a stored interior structural drawing and collect and process information, the method illustrated in FIG. 3 may be implemented by any configuration in the home network system. However, it should be noted that for convenience, the following description will be made based on an assumption that the method is implemented by the HGW of the home network system.

Referring to FIG. 3, the HGW monitors whether creation of an interior structural drawing is requested by a user in operation 310.

The HGW creates a new interior structural drawing based on basic layout information or edits a created interior structural drawing, in response to the user's interior structural drawing creation request in operation 312. The HGW may simultaneously perform creation and edition. The basic layout information refers to minimum information needed for creating the interior structural drawing.

The basic layout information may be an address of a target building for which creation of an interior structural drawing is requested. If an address is provided as the basic layout information, the HGW searches the internal DB based on the provided address. If a desired interior structural drawing may be created by the search, the HGW may not carry out additional search. For example, whether to conduct the additional search may be determined by the user. For example, the HGW provides the interior structural drawing created by searching the internal DB to the user. If the user selects to use the provided interior structural drawing, the HGW may determine that the additional search is not needed.

However, if the user selects not to use the provided interior structural drawing, the HGW determines that the additional search is needed. In this case, the HGW performs the additional search using a web search. Considering information about an interior structure collected using the web search in addition to information obtained by the search in the internal DB, the HGW creates or edits at least one recommendable interior structural drawing.

Since it is highly probable that buildings with similar addresses may have similar interior structures, the at least one recommended interior structural drawings may be created or the existing interior structural drawing may be edited using a web search. For example, apartment houses, such as villas or apartments having similar addresses, generally have similar interior structures.

Thus, the HGW searches for interior structural drawings of neighboring buildings based on address information, and provides a recommended interior structural drawing based on the search result.

In another example, in addition to the basic layout information including the address information, extended layout information including information about a target building for which the interior structural drawing is to be created may be further provided. The extended layout information may be information that may be used to construct an interior structure, such as the size of the target building, the number of floors of the building, the number of rooms of the building, and the like. The extended layout information may be included in and provided through the basic layout information.

In this case, the HGW may create a recommended interior structural drawing merely with the basic layout information and the extended layout information. For example, the HGW constructs a frame forming the interior based on the number of floors and the size of the building obtained based on the basic layout information or the extended layout information. Thereafter, the HGW divides a space in the constructed frame based on information about the number of rooms, or the like, provided as the extended layout information, thus schematically completing the interior structural drawing.

The HGW may also edit a created interior structural drawing at the request of the user. In this case, the HGW may edit the interior structural drawing based on the previously defined extended layout information or extended layout information additionally provided from the user.

For example, editing the interior structural drawing may be divided into an editing operation related to the structure of the building and an editing operation for changing the position of an internal object.

The editing operation related to the building's structure includes changing the size, shape, or position of a zone corresponding to a room, a living room, a bathroom, a screen porch, or the like, in the interior of the building or changing the form of the outlines of the interior of the building. The editing operation for changing a position of an internal object reflects changed arrangement of objects in the interior of the building, such as furniture, electronics, a lighting system, and so forth. For example, editing the interior structural drawing may be performed by a user's manipulation based on software having an interior structure editing function, such as a wizard program, a Computer-Aided Design (CAD) program, or the like.

For example, assuming that an interior structural drawing perfectly reflecting an interior structure corresponding to a layout of a building is completed, editing the interior structural drawing may be performed for arrangement of furniture, electronics, a lighting system, and so forth.

Although not described above, two operations may be performed for the layout work of the interior structure based on an operation of creating and editing the interior structural drawing.

In the first layout operation, a basic interior structural drawing may be completed based on the interior structure related to a structure of a building, that is, the size of the building, the number of floors of the building, space division, the role of each space, and the like. In the second layout operation, layout work reflecting arrangement of objects in each space of the basic interior structural drawing completed in the first layout operation may be performed to complete an extended interior structural drawing.

The first layout operation may be performed based on information registered in internal and external DBs or by an automatic creation scheme (i.e., a floor plan automatic creation scheme). The second layout operation may be performed based on manual creation using a program (i.e., a wizard scheme, a template scheme, or the like).

Upon completion of creation or edition of the interior structural drawing, the HGW outputs the created or edited interior structural drawing through the UI unit, and stores the interior structural drawing in the DB at the request of the user through the UI unit in operation 314.

The HGW monitors whether retrieving one of interior structural drawings managed in the DB is requested by the user in operation 316.

Upon detecting the user's interior structural drawing retrieve request, the HGW reads information about the interior structural drawing corresponding to the retrieve request from the DB and outputs/edits/stores the interior structural drawing through the UI unit in operation 318.

The HGW retrieves one of the interior structural drawings managed in the DB at the request of the user and outputs the interior structural drawing through the UI unit, and the output interior structural drawing is edited by the user and the interior structural drawing stored in the DB is updated with the edited interior structural drawing. Such a procedure may be processed in the same manner as the aforementioned procedure performed for a newly created interior structural drawing.

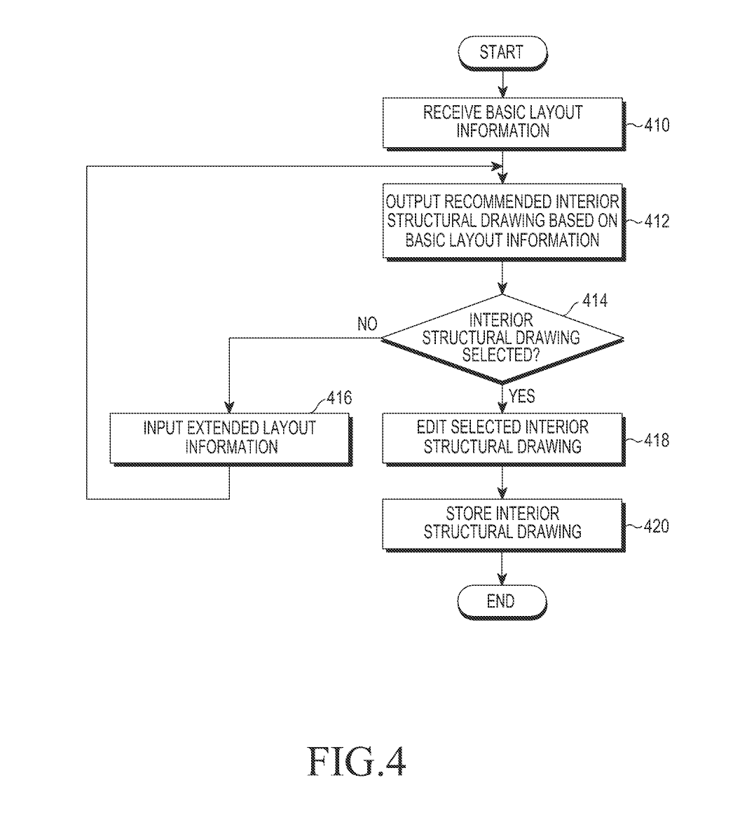

FIG. 4 is a flowchart illustrating a method for creating an interior structural drawing in a home gateway according to an embodiment of the present disclosure. FIG. 4 shows a method for creating an interior structural drawing based on basic layout information and extended layout information.

Referring to FIG. 4, the HGW receives basic layout information from the user in operation 410. Herein, the basic layout information refers to minimum information needed for creating an interior structural drawing. The minimum information may be defined differently according to the quality of an interior structural drawing to be created. For example, a scheme for creating an interior structural drawing in the most convenient method may be searching interior structural drawings managed in an internal or external DB by using an address of the building. In this case, the basic layout information has to include the address of the building.

However, to allow the HGW to directly create the interior structural drawing, more information needs to be provided. For example, in order for the HGW to directly create an interior structural drawing, extended layout information including the number of stories of the building, the size of each story, space division information, and so forth may be additionally provided.

A scheme for the HGW to directly create an interior structural drawing is divided into a scheme that needs a user's operation and a scheme that does not need the user's operation. The scheme that needs the user's operation may include the wizard scheme, the template scheme, and the like, and the scheme that does not need the user's operation may include the floor plan automatic creation scheme and so forth. Herein, the floor plan automatic creation scheme simplifies an interior structure to provide the outline of the interior, division of rooms, extraction of a name of each space, and the like using simple lines.

According to the wizard scheme, if the user inputs environment conditions, such as a story, a room, a type, and the like, a recommended interior structural drawing is searched for among interior structural drawings of the DB based on the input environment conditions, and the found recommended interior structural drawing is output. According to the wizard scheme, the quality of the created interior structural drawing may be determined depending on how accurate and how many environment conditions the user inputs.

The template scheme freely configures a template using a drag & drop function by driving a program allowing the user to create an interior structural drawing. This scheme may give more authority to create an interior structural drawing to the user, thus creating the interior structural drawing of the highest quality. Nevertheless, this scheme fails to provide user convenience.

To obtain a high-quality interior structural drawing while minimizing this issue, a rough interior structural drawing may be first completed using the automatic creation scheme or the wizard scheme, and the rough interior structural drawing may be modified using the template scheme. In this manner, a plurality of different creation schemes may be combined for implementation.

Once at least one recommended interior structural drawing is completed as described above, the HGW outputs the at least one recommended interior structural drawing through the UI unit in operation 412.

The HGW monitors whether one of the at least one recommended interior structural drawing is selected by the user in operation 414.

If one of the at least one recommended interior structural drawing is not selected by the user, the HGW determines that none of the at least one recommended interior structural drawing satisfies the user.

The HGW receives extended layout information from the user to obtain more satisfactory recommended interior structural drawings in operation 416. For example, the user may review the output at least one recommended interior structural drawing and input extended layout information determined to be additionally considered for a desired interior structural drawing.

The HGW performs an additional interior structural drawing creation operation by searching the internal or external DB or using at least one of the aforementioned schemes, based on the extended layout information for the aforementioned purpose in operation 412. The HGW outputs the at least one recommended interior structural drawing created by the additional operation based on the extended layout information through the UI unit.

If the user is satisfied with none of the at least one recommended interior structural drawing output by the additional operation, the user may input new extended layout information. In this case, the HGW may create other at least one recommended interior structural drawing based on the input new extended layout information and provide the created at least one recommended interior structural drawing to the user.

However, if the user selects one of the at least one recommended interior structural drawing, the HGW edits the selected interior structural drawing in operation 418. The operation of editing the selected interior structural drawing corresponds to the operation of reinforcing the interior structural drawing selected by the user.

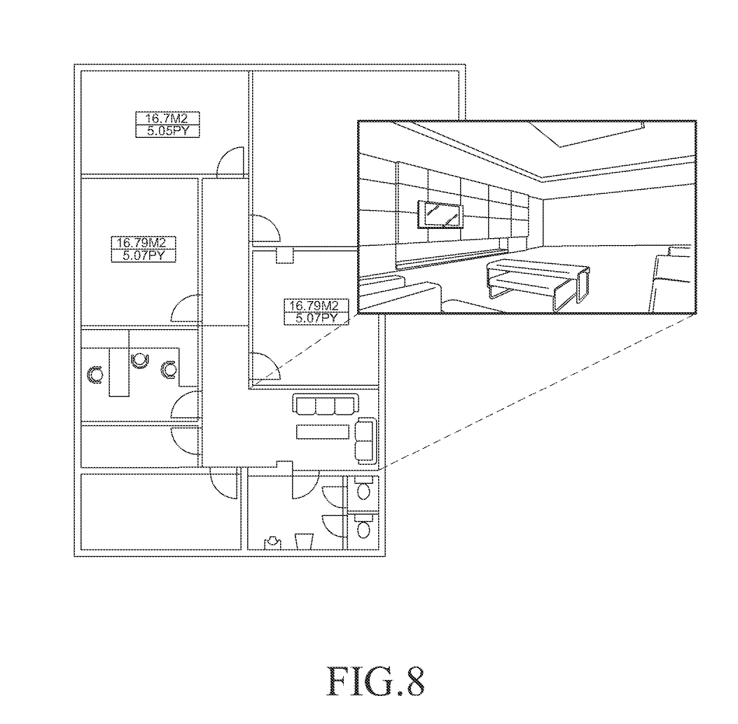

For example, the editing operation may be arranging objects, adjusting a space for dividing the interior, or adding a structure for each space in the selected interior structural drawing. Thus, a user direct processing using a tool provided by the HGW may be the most effective editing operation. Examples for the editing operation are illustrated in FIGS. 8, 9, and 10.

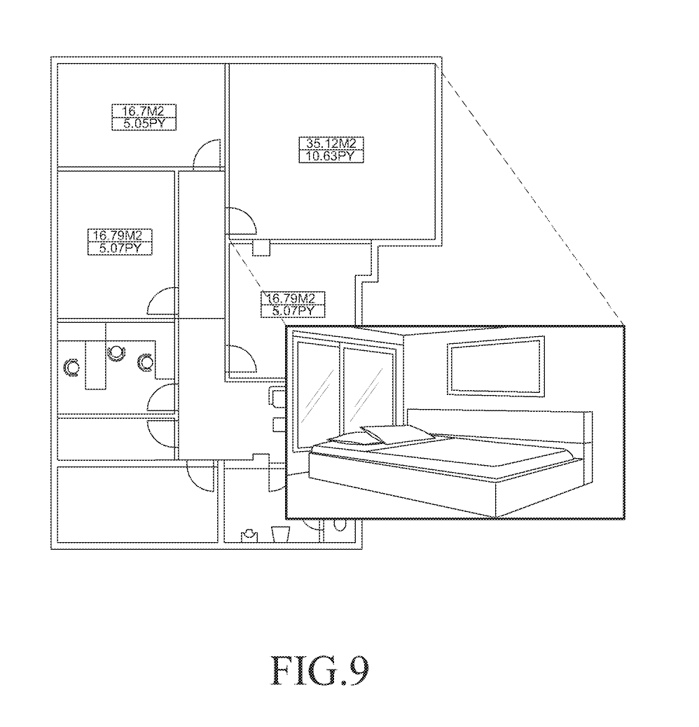

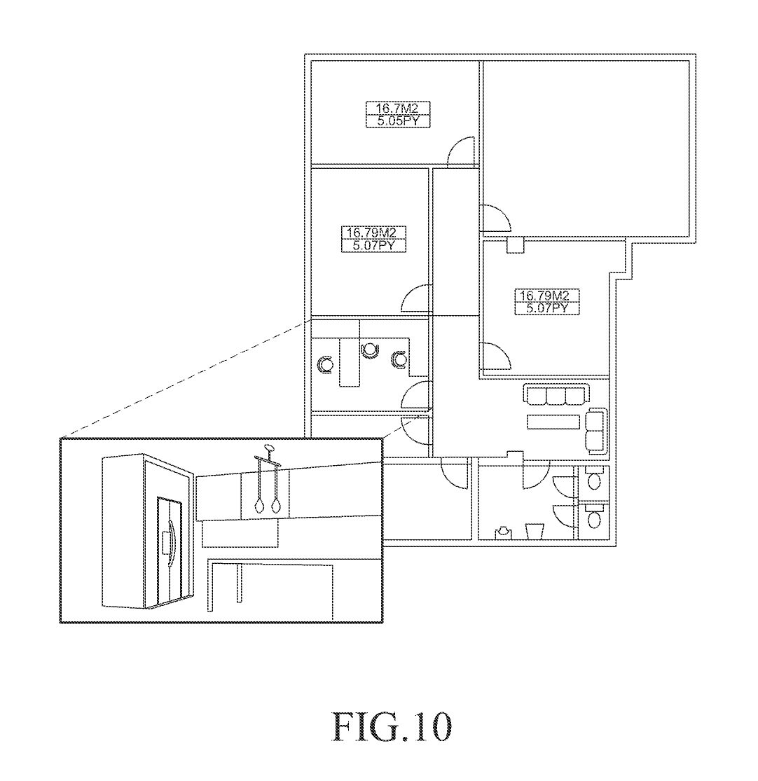

FIG. 8 illustrates an edition result after adding a structure corresponding to a living room as an image in an interior structural drawing according to an embodiment of the present disclosure. FIG. 9 illustrates an edition result after adding a structure corresponding to a sitting room as an image in an interior structural drawing according to an embodiment of the present disclosure. FIG. 10 illustrates an edition result after adding a structure corresponding to a kitchen as an image in an interior structural drawing according to an embodiment of the present disclosure.

Referring to FIGS. 8, 9, and 10, a structure corresponding to each zone in the interior structural drawing is illustrated by using an image. However, it is also possible to add different interior structural drawings corresponding to structures of zones based on a floor plan as illustrated in FIG. 6 rather than an image.

In addition to edition as illustrated in FIGS. 8, 9, and 10, edition, such as addition of a new zone to a created interior structural drawing, removal of an existing zone from the created interior structural drawing, integration of a plurality of zones in the created interior structural drawing, division of one zone into two zones, and change of a name for identifying a zone may also be possible. The HGW may also provide an Undo or Redo function to improve the convenience of edition. A zone that is a target for edition in the interior structural drawing is a space for dividing the interior and may be a room, a bathroom, a living room, or the like.

The HGW stores the created interior structural drawing or the edited interior structural drawing in the DB in response to the user's request in operation 420. The HGW may also register the created interior structural drawing or the edited interior structural drawing in an external DB through an external network, such as the Internet.

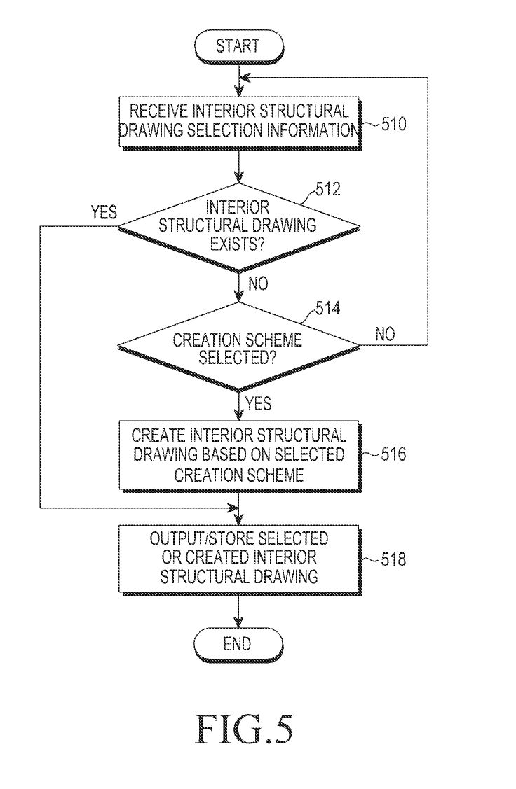

FIG. 5 is a flowchart illustrating a method for creating an interior structural drawing in a HGW according to an embodiment of the present disclosure.

Referring to FIG. 5, the HGW receives interior structural drawing selection information for selecting an interior structural drawing from the user in operation 510. The interior structural drawing selection information refers to information used for selecting an interior structural drawing. The interior structural drawing selection information may be defined differently according to a mode for creating an interior structural drawing. If an interior structural drawing is recommended based on a DB that manages various interior structural drawing examples, the interior structural drawing selection information may be defined by an address. The interior structural drawing selection information may also include information that allows construction of an interior structure, for example, information about the number of stories of a building, the size of each story, and a room, a living room, a bathroom, and a screen porch in each story.

The interior structural drawing selection information may also include a combination of the information described in the two examples.

Upon receiving the interior structural drawing selection information, the HGW determines whether at least one interior structural drawing that may be recommended based on the received interior structural drawing selection information exists in an internal DB or an accessible external DB, in operation 512.

If there is at least one recommendable interior structural drawing, the HGW outputs the at least one recommendable interior structural drawing through the UI unit to allow the user to review the at least one interior structural drawing in operation 518. If the user selects one of the at least one interior structural drawing output through the UI unit, the HGW stores the user-selected interior structural drawing in the internal or external DB.

Otherwise, if there is no recommendable interior structural drawing in the internal or external DB, the HGW asks the user to select a creation scheme for creating an interior structural drawing through the UI unit. The HGW monitors which creation scheme, that is, which creation mode is selected by the user in operation 514.

The creation scheme that may be selected by the user may include automatic creation, wizard-based creation, template-based creation, and the like. In addition to these examples, various schemes for creating an interior structural drawing may also be used.

The automatic creation, the wizard-based creation, and the template-based creation have already been described and thus, will not be described at this time.

Once the creation scheme is selected by the user, the HGW creates an interior structural drawing based on the selected creation scheme in operation 516. For example, if the user selects automatic creation, an interior structural drawing in the form of a simplified floor plan may be created using the user-provided interior structural drawing selection information or interior structural drawing selection extended information additionally provided from the user.

If the user selects wizard-based creation, the HGW drives a wizard, that is, a program, for creating an interior structural drawing. The user inputs environment conditions based on a GUI of the driven program through the UI unit to search for a similar interior structural drawing, and selects an optimal interior structural drawing based on the search result. The user may edit the optimal interior structural drawing selected based on the GUI corresponding to the wizard to create a desired interior structural drawing.

If the user selects template-based creation, the HGW drives a GUI corresponding to a program capable of freely configuring a template based on a drag & drop function. The user may directly create an interior structural drawing based on the driven GUI.

Upon completion of creation of the interior structural drawing in this manner, the HGW outputs the created interior structural drawing through the UI unit and stores the interior structural drawing created at the request of the user in an internal or external DB.

According to an embodiment of the present disclosure, an interior structural drawing used for a home network system may be easily created and may also be edited, providing user convenience.

Other effects that may be obtained or expected from the embodiment of the present disclosure are explicitly or implicitly disclosed in the embodiment of the present disclosure. For example, various effects expected from the embodiment of the present disclosure have been disclosed in the detailed description of the present disclosure.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A Home GateWay (HGW) for providing an interior structural drawing of a building, the HGW comprising:
a User Interface (UI) unit;
a DataBase (DB) configured to manage interior structural drawings based on identification information;
a communication unit configured to communicate with an external network; and
a structural drawing unit configured to receive a request of a user from the UI unit, to obtain at least one recommended interior structural drawing by searching at least one of the DB and an external DB, which is accessible through the communication unit, based on the basic layout information, to provide the at least one recommended interior structural drawing through the UI unit, and to edit the interior structural drawing selected by the user based on extended layout information.

2. The HGW of claim 1, wherein the structural drawing unit is further configured to add an interior structural drawing selected by the user from among the at least one recommended interior structural drawing to the DB, and to add the edited interior structural drawing to the DB at the request of the user.

3. The HGW of claim 2, wherein the basic layout information comprises address information of a building for which creation of an interior structural drawing is requested, and
wherein the structural drawing unit is further configured to search the DB based on the address information, to search the external DB based on the address information if a result of the searching of the DB is determined to be unsatisfactory for interior structural drawing recommendation, and to creates at least one recommended interior structural drawing based on a result of the searching of the DB or a result of the searching of the DB and the external DB.

4. The HGW of claim 3, wherein the structural drawing unit is further configured to request the user to provide extended layout information through the UI unit, if it is determined that the result of the searching of the DB and the external DB based on the address information is unsatisfactory for interior structural drawing recommendation, and to obtain at least one recommended interior structural drawing, additionally considering the extended layout information of the user provided from the UI unit in response to the request for providing the extended layout information.

5. The HGW of claim 4, wherein the extended layout information comprises at least one of a number of floors of the building, a size of each floor, division of zones of each floor, and an arrangement of furniture, electronics, and a lighting system.

6. The HGW of claim 5, wherein the extended layout information is included in and provided through the basic layout information.

7. The HGW of claim 2, wherein the structural drawing unit is further configured to receive a request for retrieving one of interior structural drawings stored in the DB from the UI unit, to read the interior structural drawing from the DB and outputs the read interior structural drawing through the UI unit in response to the request, to edit the interior structural drawing output through the UI unit at the request of the user, and to update the DB with the edited interior structural drawing at the request of the user.

8. The HGW of claim 7, wherein the editing of the selected interior structural drawing or the output interior structural drawing is performed at the request of the user who refers to a screen output through the UI unit using a wizard program or a Computer-Aided Design (CAD) program that supports an interior structural drawing editing operation.

9. The HGW of claim 1, wherein the structural drawing unit is further configured to edit the structure of the building and to edit the position of an internal object.

10. The HGW of claim 9, wherein the interior structural drawings are used to measure and manage a lighting environment and a power consumption of each space that divides the interior.

11. A method for providing an interior structural drawing of a building by a Home GateWay (HGW) that comprises a User Interface (UI) unit, a DataBase (DB) configured to manage interior structural drawings based on identification information, and a communication unit configured to communicate with an external network, the method comprising:
receiving a request of a user from the UI unit;
obtaining at least one recommended interior structural drawing by searching at least one of the DB and an external DB, which is accessible through the communication unit, based on the basic layout information;
providing the at least one recommended interior structural drawing through the UI unit; and
editing an interior structural drawing selected by the user from among the at least one recommended interior structural drawing based on the extended layout information.

12. The method of claim 11, further comprising:
adding the selected interior structural drawing or the edited interior structural drawing to the DB in response to a user's request provided from the UI unit.

13. The method of claim 12, wherein the basic layout information comprises address information of a building for which creation of an interior structural drawing is requested, and wherein the method further comprises:
searching the DB based on the address information, and searching the external DB based on the address information if a result of the searching of the DB is determined to be unsatisfactory for interior structural drawing recommendation; and
creating at least one recommended interior structural drawing based on a result of the searching of the DB or a result of the searching of the DB and the external DB.

14. The method of claim 12, further comprising:
requesting the user to provide extended layout information through the UI unit, if it is determined that the result of the searching of the DB and the external DB based on the address information is unsatisfactory for interior structural drawing recommendation; and
obtaining at least one recommended interior structural drawing, additionally considering the extended layout information of the user provided from the UI unit in response to the request for providing the extended layout information.

15. The method of claim 13, wherein the extended layout information comprises at least one of a number of floors of the building, a size of each floor, division of zones of each floor, and an arrangement of furniture, electronics, and a lighting system.

16. The method of claim 14, wherein the extended layout information is included in and provided through the basic layout information.

17. The method of claim 12, further comprising:
receiving a request for retrieving one of interior structural drawings stored in the DB from the UI unit and reading the interior structural drawing from the DB and outputting the read interior structural drawing through the UI unit in response to the request;
editing the interior structural drawing output through the UI unit at the request of the user; and
updating the DB with the edited interior structural drawing at the request of the user.

18. The method of claim 17, wherein the editing of the selected interior structural drawing or the output interior structural drawing is performed at the request of the user who refers to a screen output through the UI unit using a wizard program or a Computer-Aided Design (CAD) program that supports an interior structural drawing editing operation.

19. The method of claim 11, wherein the editing of the interior structural drawing selected by the user comprises an editing operation for the structure of the building and an editing operation for changing the position of an internal object.

20. The method of claim 19, wherein the interior structural drawings are used to measure and manage a lighting environment and a power consumption of each space that divides the interior.
